(19) United States
(12) Patent Application Publication
(10) Pub. No.: US 2026/0106674 A1
(43) Pub. Date: Apr. 16, 2026

(54) FR3 NX1 INTEGRATED CONDUCTIVE SWITCH FOR 6G DEVICES

(71) Applicant: Mediatek Inc., Hsinchu (TW)

(72) Inventors: Sang-June Park, San Jose, CA (US); Hsin-Hung Chen, Hsinchu (TW); Hsiang-Hui Chang, Hsinchu (TW); David Ritter, San Jose, CA (US)

(21) Appl. No.: 19/343,723

(22) Filed: Sep. 29, 2025

Related U.S. Application Data
(60) Provisional application No. 63/707,273, filed on Oct. 15, 2024.

(51) Int. Cl. H04B 17/19; H04B 7/06

(52) U.S. Cl. CPC H04B 17/19; H04B 7/0608

(57) ABSTRACT

In an aspect of the disclosure, a communication system is provided. The communication system is an integrated conductive switch. The integrated conductive switch includes a unified structural framework. The integrated conductive switch includes N conductive switch elements integrated within the unified structural framework. N is an integer greater than 2. In a signal path mode, the N conductive switch elements route radio frequency (RF) signals between a front-end module (FEM) and an antenna panel. In a testing mode, the N conductive switch elements route the RF signals between the FEM and a test equipment.

### CROSS-REFERENCE TO RELATED APPLICATION(S)

This application claims the benefits of U.S. Provisional Application Ser. No. 63/707,273, entitled “FR3 MIMO 4×1 Conductive Switch for 6G Handsets” and filed on Oct. 15, 2024, which is expressly incorporated by reference herein in its entirety.

### BACKGROUND

### Field

The present disclosure relates generally to radio frequency (RF) testing systems, and more particularly, to FR3 Nx1 Integrated Conductive Switch for 6G Devices.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Frequency Range 1 (FR1: 600 MHz-7 GHz) systems, which are utilized in various wireless communication technologies such as 4G LTE, 5G NR, Wi-Fi 6/6E, and IoT applications, employ discrete conductive switches (e.g., PIN diode switches, GaAs FETs) to selectively route signals between antennas and RF chains. In a mobile device supporting FR1, antennas are typically distributed around the device, and each antenna is associated with a dedicated conductive switch. Specifically, for FR1, each RF chain requires an individual switch with separate solder lands (e.g., 1.2-2.5 mm² per switch), which increases the layout complexity in multi-antenna configurations. Additionally, the requirement for individual conductive testing per RF chain results in extended validation time.

Frequency Range 2 (FR2: 24-44 GHz) systems, designed for millimeter-wave (mmWave) applications in 5G NR, rely on Over-the-Air (OTA) testing due to the inseparable co-integration of phased-array antennas and front-end modules (FEMs). OTA testing inherently incorporates the antenna radiation characteristics, which obscures the standalone performance metrics of the FEMs, such as power amplifier linearity and low-noise amplifier noise figure. This is because the antenna is an integral part of the OTA testing process. Consequently, OTA testing requires the use of an anechoic chamber, which is both costly and time-consuming, making it impractical for high-volume production.

The development of 6th Generation (6G) Frequency Range 3 (FR3) systems, operating within the 7 GHz to 16 GHz frequency spectrum, necessitates the creation of an optimized RF testing methodology. This methodology is essential to validate key performance metrics, such as insertion loss, linearity, and signal integrity, in a more efficient and cost-effective manner.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a communication system is provided. The communication system is an integrated conductive switch. The integrated conductive switch includes a unified structural framework. The integrated conductive switch includes N conductive switch elements integrated within the unified structural framework. N is an integer greater than 2. In a signal path mode, the N conductive switch elements route radio frequency (RF) signals between a front-end module (FEM) and an antenna panel. In a testing mode, the N conductive switch elements route the RF signals between the FEM and a test equipment.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an FR3 communication system.

FIG. 8(A) is a diagram illustrating the signal routing during normal operation.

FIG. 8(B) is a diagram illustrating the signal routing during testing operation.

FIG. 9 illustrates a flow chart of a process for conductive switching.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

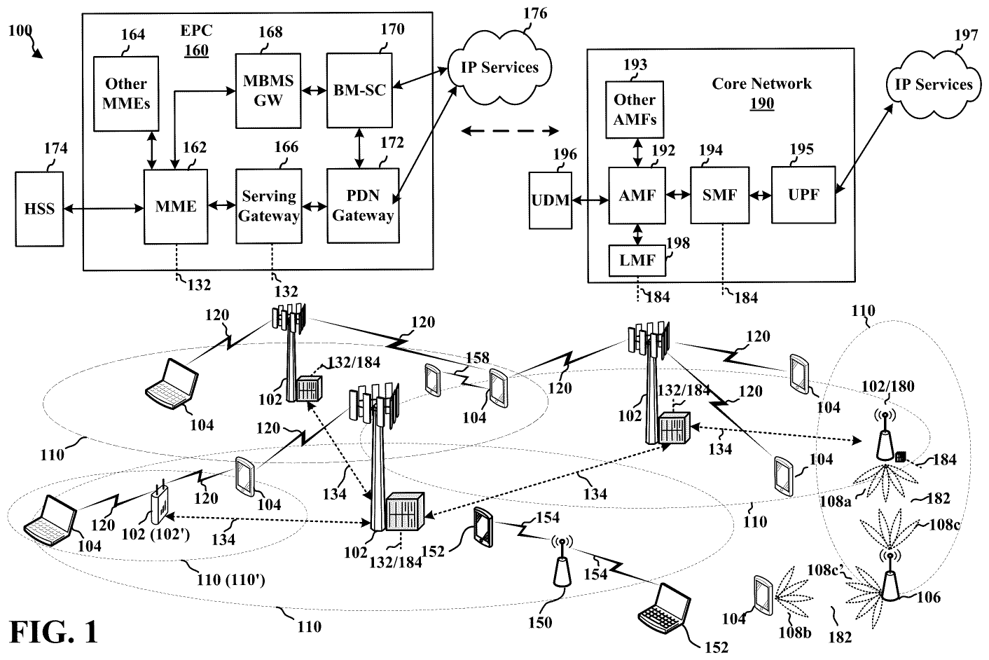

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

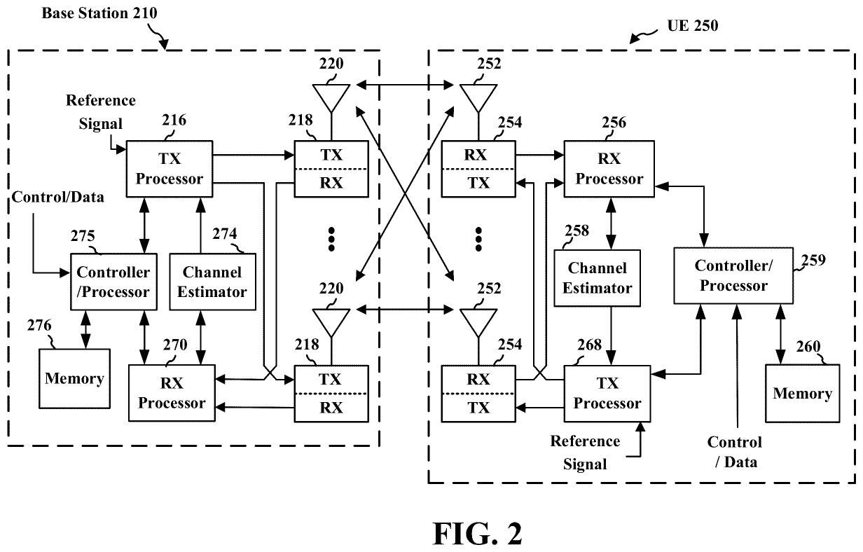

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

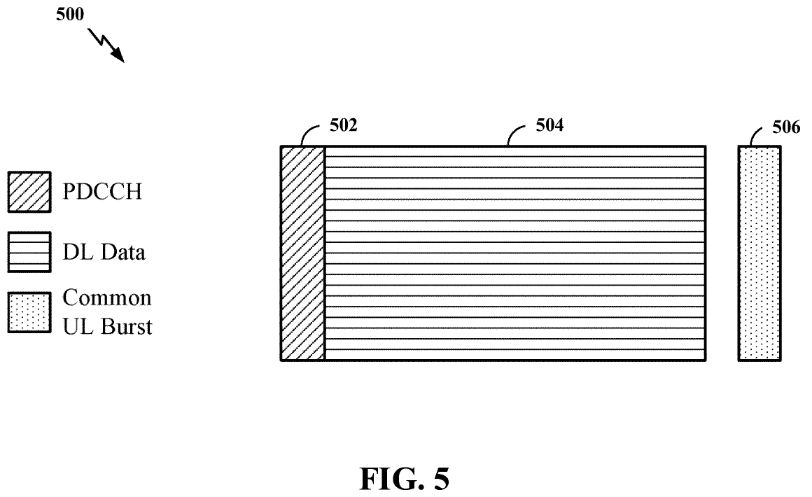

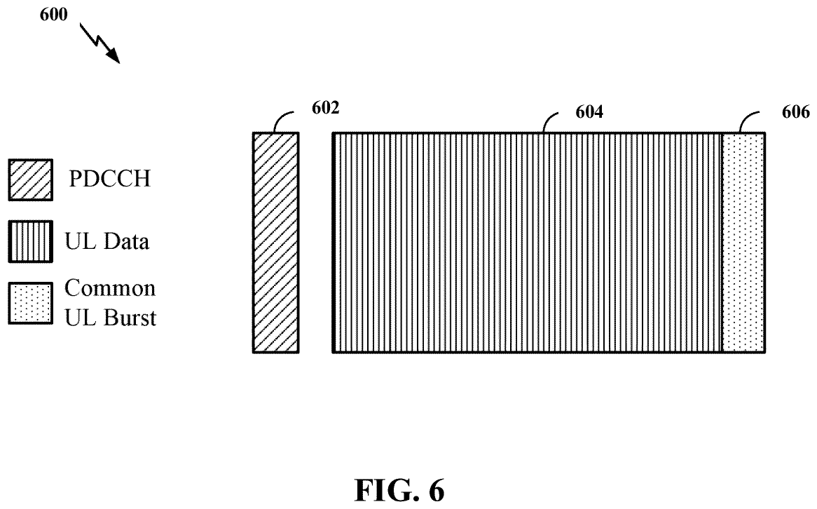

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

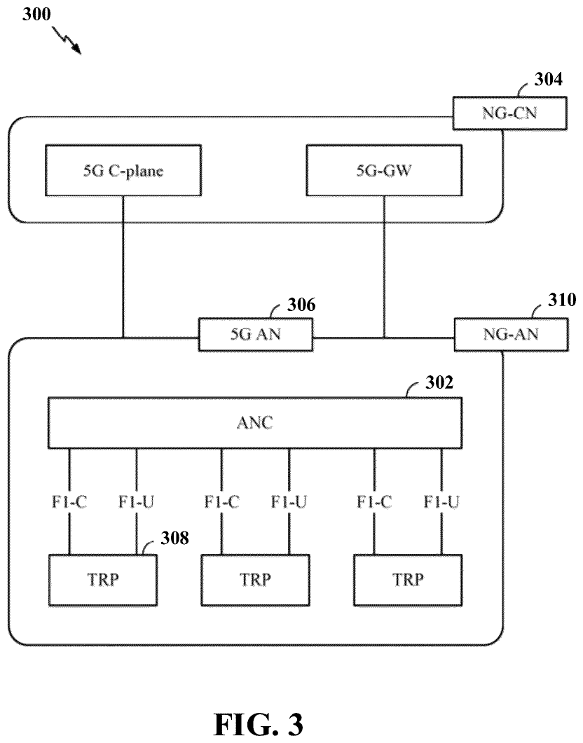

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

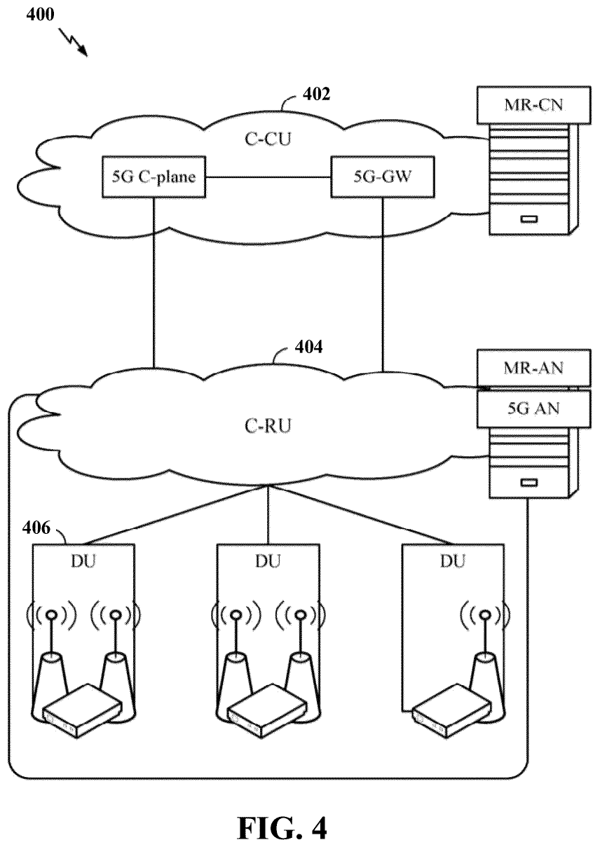

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

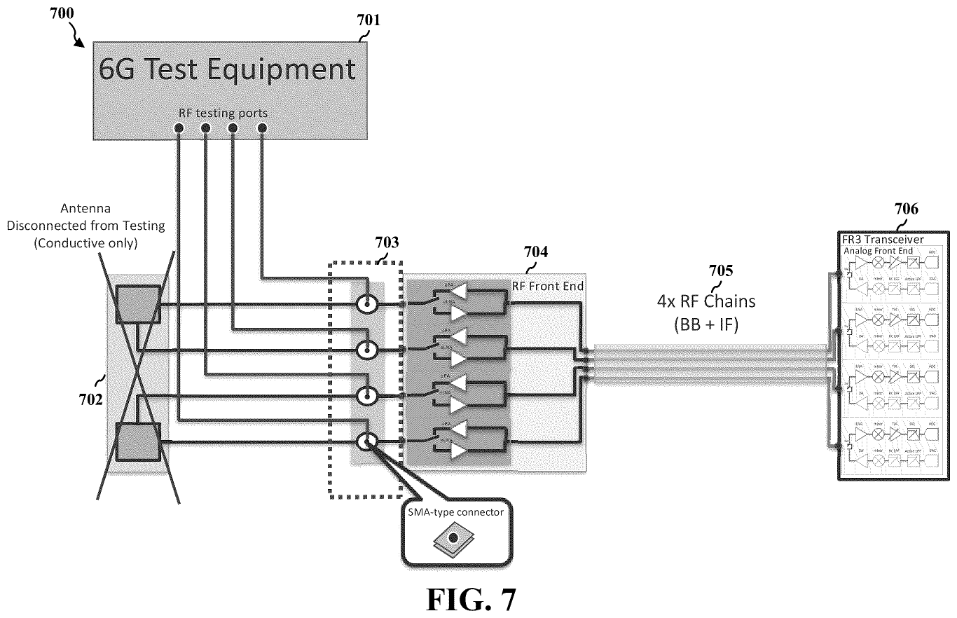

FIG. 7 is a diagram 700 illustrating an FR3 communication system. The system includes: a 6G test equipment 701 configured to generate and analyze FR3 test signals; an antenna panel 702 including a plurality of antenna elements; a conductive switch 703 operatively coupled between the test equipment 701 and the antenna panel 702, configured to selectively route signals from either the test equipment 701 or the antenna panel 702 to the RF FEM 704; an RF chain 705 coupled to the RF FEM 704 and configured to enable communication between the RF FEM 704 and an FR3 transceiver 706; and the FR3 transceiver 706, which interfaces with the RF chain 705 for signal modulation and demodulation.

In the example of FIG. 7, the antenna panel 702 includes dual-polarized antenna elements arranged in a 2×1 (two rows, one column) configuration. Alternatively, the antenna elements may be arranged in a 4×1 configuration or other suitable configurations. Within the antenna panel 702, adjacent antenna elements are co-located and aligned in a co-directional orientation to minimize spatial separation. Additionally, the dual-polarized design (e.g., vertical and horizontal polarization) enables spatial diversity and multi-input multi-output (MIMO) operation within a compact form factor, thereby reducing the overall footprint of the system. Moreover, the antenna elements may be further optimized for FR3 frequency band operation through impedance matching networks and substrate-integrated waveguide (SIW) structures to mitigate surface wave losses.

The conductive switch 703 is configured to operate within a predefined frequency range corresponding to FR3. The specifications of the conductive switch 703 may include:
(1) Low insertion loss (such as less than 0.5 dB or 1 dB);
(2) A third-order input intercept point (IIP3) greater than (PA Pmax+10 dB), where PA Pmax represents the maximum output power of a power amplifier integrated within the RF FEM 704, with other linearity specifications (e.g., a second-order input intercept point (IIP2) and a fifth-order input intercept point (IIP5)) not being precluded; and
(3) Deprioritized parameters, including switching speed and isolation (due to acceptable long transient time between testing and operational mode, and non-concurrent testing and operational mode).

In this disclosure, switching speed and isolation are secondary design parameters, which are prioritized below insertion loss and linearity specs like IIP3 (although insertion loss is likely limiting spec over linearity specs for passive switch).

The switch 703 may function as a multi-line interboard connector (e.g., an SMA-type coaxial connector) configured to transmit both digital control signals and RF signals between a first circuit board (e.g., an antenna board) and a second circuit board (e.g., an RF processing board).

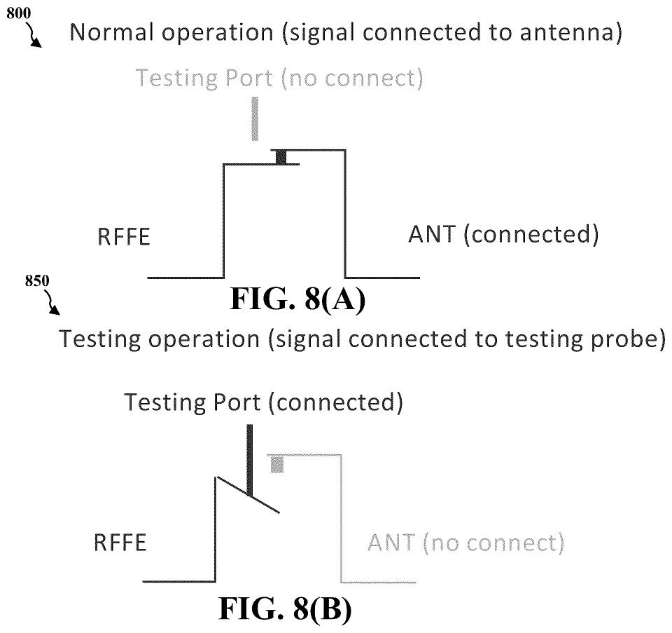

FIG. 8(A) is a diagram 800 illustrating the signal routing during normal operation; and FIG. 8(B) is a diagram 850 illustrating the signal routing during testing operation. In a first operational state for normal operation, as illustrated in FIG. 8(A), the switch 703 establishes a conductive path between the RF FEM 704 and the antenna panel 702 while disconnecting the testing port of the test equipment 701. This configuration routes RF signals generated by the FR3 transceiver 706 through the RF FEM 704 to the antenna panel 702 for wireless transmission. Low loss is optimized for this mode and connection.

In a second operational state for testing operation, as illustrated in FIG. 8(B), actuated by a physical connection of a test cable to the switch 703, the conductive path between the RF FEM 704 and the antenna panel 702 is interrupted. The switch 703 mechanically redirects RF signals bidirectionally between the RF FEM 704 and the testing port of the test equipment 701, enabling conductive performance analysis of the RF FEM 704, the RF chain 705 and the transceiver 706. That is, the physical connection of the test cable may function as a mode selection signal to selectively cause the system 700 to operate in either the signal path mode or the testing mode. Performance (loss, linearity) in this mode (test mode) is secondary to the loss in the primary mode.

The switch 703 is adapted for electrical characterization of microwave circuits in wireless communication devices, including, but not limited to, personal computers, tablets, cellular phones, and base station equipment operating within the FR3 frequency range. For example, the cellular phones may be the UE 104, and the base station equipment may be the base station 102.

The RF FEM 704 may integrate a low-noise amplifier (LNA) for amplifying received signals, a power amplifier (PA) for transmitting signals, and bandpass filters centered at FR3 frequencies to suppress out-of-band interference. The FEM 704 may further include a bidirectional coupler for real-time monitoring of forward and reflected power levels.

Furthermore, the RF FEM 704 may include: a phase shifter integrated with the PA or LNA for beamforming applications in phased-array systems; a bias control circuit configured to dynamically adjust operating parameters of the PA and LNA based on signal power levels; and an impedance matching network disposed between the antenna panel 702 and the TX/RX paths to minimize signal reflection.

The RF chain 705 may include a series of programmable gain stages, mixers, and analog-to-digital converters (ADCs), configured to upconvert and downconvert FR3 signals between baseband and RF frequencies. The RF chain 705 may be calibrated to maintain signal integrity metrics across the FR3 spectrum.

The FR3 transceiver 706 may include analog front ends. Additionally, the FR3 transceiver 706 may incorporate a digital signal processor (DSP) and beamforming circuitry to support adaptive modulation schemes and phased-array beam steering for 6G applications.

As illustrated in FIG. 7, the RF FEM 704 incorporates four independent output channels, each configured to process and amplify RF signals within the FR3 frequency range. Correspondingly, the RF chain 705 includes four RF channels (Baseband-to-Intermediate Frequency, BB+IF). The four discrete RF channels are operatively coupled to the four outputs of the RF FEM 704.

Specifically, each RF channel may include: a baseband (BB) processing unit, an Intermediate Frequency (IF) conversion module, and an RF interface circuitry. The BB processing unit may include a digital signal processor (DSP) configured to modulate and demodulate baseband signals using orthogonal frequency-division multiplexing (OFDM) or similar schemes. The IF conversion module may perform frequency translation. For example, the IF conversion module may include a mixer coupled to a local oscillator (LO) for upconverting baseband signals to a predefined IF range, as well as an IF amplifier and filter chain to condition the translated signals. The RF interface circuitry may include impedance-matching networks and programmable attenuators to optimize signal integrity between the IF stage and the RF FEM.

The transceiver 706 may also integrate four input ports, each directly interfacing with one of the four RF channels. The transceiver 706 may include an Analog Front-End (AFE) subsystem and a DSP core. For example, the AFE may include a low-noise amplifier (LNA) array for received signal amplification, analog-to-digital converters (ADCs) and digital-to-analog converters (DACs), and reconfigurable anti-aliasing filters adjustable based on operational bandwidth. The DSP core may be a field-programmable gate array (FPGA) or an application-specific integrated circuit (ASIC) implementing error correction, beamforming algorithms, and channel equalization.

In a transmit path, baseband signals generated by the transceiver 706 are upconverted to the IF range within the respective channel of the RF chain 705. Then, IF signals are routed to the RF FEM 704, where they are further upconverted to the target RF frequency, amplified, and filtered. Finally, the amplified RF signals are transmitted via the antenna panel 702.

In a receive path, RF signals received by the antenna panel 702 are conditioned by the RF FEM 704 (e.g., low-noise amplification, filtering). Subsequently, conditioned RF signals are downconverted to the IF range within the RF chain 705. Then, the IF signals are digitized by the transceiver 706 for subsequent baseband processing.

The multi-channel RF chain 705 enables simultaneous processing of multiple independent data streams, supporting multi-user multiple-input multiple-output (MU-MIMO) operations and increasing system throughput.

The architecture is configured to allow for seamless expansion to N RF channels, where N is an integer greater than 2. This expansion may be achieved by replicating the baseband and intermediate frequency (BB+IF) modules and transceiver input ports, thereby accommodating future bandwidth demands without requiring a redesign of the RF FEM 704. The scalable architecture facilitates cost-effective upgrades and adaptability to evolving communication standards.

The present disclosure provides an integrated N×1 conductive switching assembly 703, where N is an integer greater than 2. The conductive switching assembly may be configured to route RF signals bidirectionally between the RF FEM 704 and the antenna panel 702 during normal operation (signal path mode), and between the FEM 704 and test equipment 701 during conductive testing (testing mode). The assembly may integrate N conductive switch elements into a single surface-mountable unit. The conductive switch elements may share a unified structural framework. This integration may reduce PCB layout complexity by utilizing a single soldering land pattern. The unified solder land pattern may include a plurality of contact pads distributed along a preset trace on the single assembly. For example, the contact pads are arranged in 4×1 configuration.

The conductive switch 703 may exhibit low-loss performance, such as an insertion loss of ≤0.5 dB within the FR3 frequency range.

In the example illustrated in FIG. 7, the conductive switch 703 has a 4×1 configuration, and the four conductive switch elements are integrated into the unified structural framework. However, the conductive switch 703 may also be implemented in other configurations, such as an 8×1 configuration or any N×1 configuration where N is an integer greater than 2.

Additionally, the conductive switching assembly may be utilized in various applications, including but not limited to 5G/6G communication systems, IoT devices, and satellite communication systems. The assembly's modular design and scalable configuration facilitate adaptability to diverse operational requirements and future technological advancements.

A shared housing may be configured to encapsulate all switching elements. Adjacent switch elements may be separated by a fixed spacing, which is defined by the housing's internal structure. Additionally, a unified power distribution network may be integrated within the housing to minimize parasitic inductance, particularly at FR3 frequencies.

The housing may be constructed from a conductive material, such as aluminum or copper, to provide electromagnetic shielding. The fixed spacing between adjacent switch elements may vary depending on the operational frequency range or specific application requirements. Furthermore, the unified power distribution network may include low-inductance traces or vias to further enhance performance at high frequencies.

In the unified structural framework, all switching elements are arranged on a single PCB mounting surface. This framework includes a common solder land pattern that accommodates all RF input/output ports, test ports, and control terminals, thereby simplifying PCB layout and assembly.

The conductive switch 703 may include various mounting configurations to enhance design flexibility. In one embodiment, the conductive switch 703 is a standalone surface-mountable unit operatively coupled to the RF FEM 704 and the antenna panel 702. In another embodiment, the conductive switch 703 is a functional submodule embedded within the FEM 704. In yet another embodiment, the conductive switch 703 is a structural component integrated into the antenna panel 702. Such configurable integration with the FEM 704 or the antenna panel 702 accommodates diverse 6G device form factors, thereby enabling enhanced design flexibility and adaptability to various applications, including but not limited to 5G/6G, IoT, and satellite communication systems.

In the normal operation mode, the conductive switch 703 is configured to route RF signals between the FEM 704 and the antenna panel 702 via a low-loss conductive path (e.g., with an insertion loss of ≤0.5 dB), thereby enabling wireless transmission and reception. In the conductive testing mode, actuation of the switching assembly 703 (e.g., via physical cable connection to test equipment 701, wireless control, or automated testing protocols) disconnects the antenna panel 702 and redirects RF signals bidirectionally between the FEM 704 and the test equipment 701. This configuration bypasses radiation-dependent OTA calibration, thereby simplifying testing and calibration procedures.

The integrated conductive switch 703 reduces costs by eliminating multiple discrete switches and OTA testing infrastructure dependencies and simplifying PCB layout with unified solder land patterns. Furthermore, the integrated conductive switch 703 may minimize signal degradation through optimized high-frequency impedance matching within an integrated housing and improve mechanical stability due to fixed inter-switch spacing and shared structural supports.

The 6G FR3 system utilizes compact N×1 (where N is an integer greater than 2) integrated RF conductive testing switches, enabling the adoption of an N×1 integrated non-array antenna system. This configuration reduces implementation costs, OTA testing time, and the PCB footprint, while also lowering overall component costs and simplifying design and testing processes. Additionally, the low-loss switch is configured to test the high-frequency signal path between the front-end module and the antenna.

The present disclosure may be applicable to 6G FR3-enabled devices including cellular handsets, base stations, and IoT equipment, enabling scalable conductive testing without compromising high-frequency signal integrity.

As described supra, in certain configurations, the integrated conductive switch 703 includes a unified structural framework that integrates N conductive switch elements, where N is an integer greater than 2. In operation, the switch 703 has two primary modes: (1) a signal path mode illustrated in FIG. 8(A), where RF signals are routed between the RF FEM 704 and the antenna panel 702; and (2) a testing mode illustrated in FIG. 8(B), where RF signals are routed between the RF FEM 704 and the test equipment 701.

The switch 703 is configured to mechanically redirect RF signals from the FEM 704 to the test equipment 701 when actuated by a physical connection of a test cable to the switch 703. This physical connection functions as a mode selection signal to transition the system 700 between signal path mode and testing mode.

The switch 703 supports multiple integration configurations: (1) as a standalone surface-mountable unit on a PCB, operatively coupled to the RF FEM 704 and antenna panel 702; (2) as a functional submodule embedded within the FEM 704; or (3) as a structural component integrated into the antenna panel 702.

The unified structural framework includes a shared housing that encapsulates all N switch elements. Within this housing, adjacent switch elements are separated by a fixed spacing defined by the housing's internal structure. The framework incorporates a unified power distribution network to minimize parasitic inductance at FR3 frequencies.

The unified structural framework features a single PCB mounting surface with a unified solder land pattern. This pattern includes multiple contact pads distributed along a preset trace on the single assembly. For example, in a 4×1 configuration, the contact pads are arranged to accommodate four switch elements.

The switch 703 is designed to achieve: an insertion loss of ≤0.5 dB within the FR3 frequency range; and/or an IIP3 greater than (PA_{Pmax}+10 dB), where PA_{Pmax} represents the maximum output power of the power amplifier in the RF FEM 704.

In the exemplary implementation, the switch 703 has a 4×1 configuration with four integrated switch elements. The switch 703 is configured to operate within the FR3 frequency range of 7-15 gigahertz for 6G applications.

The switch 703 functions as a multi-line interboard connector (e.g., SMA-type coaxial connector) capable of transmitting both digital control signals and RF signals between different circuit boards, such as between an antenna board and an RF processing board.

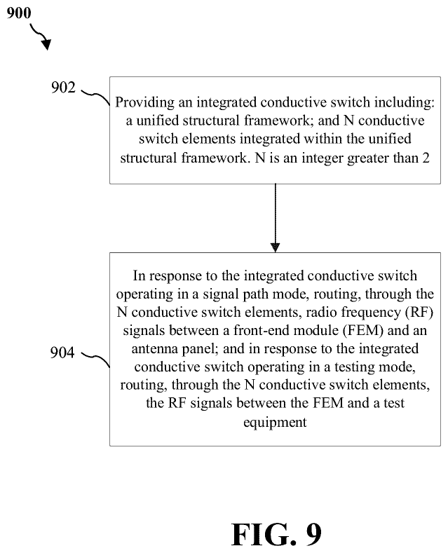

FIG. 9 illustrates a flow chart 900 of a process for conductive switching. At block 902, the process includes: providing an integrated conductive switch including: a unified structural framework; and N conductive switch elements integrated within the unified structural framework. N is an integer greater than 2.

At block 904, in response to the integrated conductive switch operating in a signal path mode, the N conductive switch elements routes radio frequency (RF) signals between a front-end module (FEM) and an antenna panel; and in response to the integrated conductive switch operating in a testing mode, the N conductive switch elements routes the RF signals between the FEM and a test equipment.

In certain configurations, routing the RF signals between the FEM and the test equipment may include: mechanically directing, by the integrated conductive switch, the RF signals from the FEM to the test equipment in response to a physical connection of a test cable.

In certain configurations, the integrated conductive switch may be one of a single assembly surface-mountable on a printed circuit board (PCB), a single assembly merged into the FEM, or a single assembly merged into the antenna panel.

In certain configurations, the unified structural framework may include a shared housing configured to encapsulate the N conductive switch elements.

In certain configurations, adjacent conductive switch elements within the shared housing may be separated by a fixed spacing.

In certain configurations, the process may further include: integrating a unified power distribution network within the unified structural framework.

In certain configurations, a multi-line interboard connector included in the integrated conductive switch transmits both digital control signals and RF signals between a first circuit board and a second circuit board.

The present disclosure also provides an integrated conductive switch. The integrated conductive switch includes: a unified structural framework; and N conductive switch elements integrated within the unified structural framework. N is an integer greater than 2. The N conductive switch elements are configured to: (a) in a signal path mode, route radio frequency (RF) signals between a front-end module (FEM) and an antenna panel; and (b) in a testing mode, route the RF signals between the FEM and a test equipment.

In certain configurations, the integrated conductive switch may mechanically direct the RF signals from the FEM to the test equipment in response to a physical connection of a test cable.

In certain configurations, the integrated conductive switch may be a single assembly surface-mountable on a printed circuit board (PCB).

In certain configurations, the integrated conductive switch may be a single assembly merged into the FEM.

In certain configurations, the integrated conductive switch may be a single assembly merged into the antenna panel.

In certain configurations, the unified structural framework may include a shared housing configured to encapsulate the N conductive switch elements.

In certain configurations, adjacent conductive switch elements within the shared housing may be separated by a fixed spacing.

In certain configurations, the integrated conductive may further include a unified power distribution network integrated within the unified structural framework.

In certain configurations, the unified structural framework may include a single PCB mounting surface having a unified solder land pattern.

In certain configurations, the unified solder land pattern may include a plurality of contact pads distributed along a preset trace on the single PCB mounting surface.

In certain configurations, N equals 4 and the N conductive switch elements may be arranged in a 4×1 configuration.

In certain configurations, the integrated conductive switch may be configured to operate within a frequency range 3 (FR3) frequency range of 7-15 gigahertz.

In certain configurations, the integrated conductive switch may include a multi-line interboard connector configured to transmit both digital control signals and RF signals between a first circuit board and a second circuit board.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An integrated conductive switch, comprising:
a unified structural framework; and
N conductive switch elements integrated within the unified structural framework, wherein N is an integer greater than 2;
wherein the N conductive switch elements are configured to:
(a) in a signal path mode, route radio frequency (RF) signals between a front-end module (FEM) and an antenna panel; and
(b) in a testing mode, route the RF signals between the FEM and a test equipment.

2. The integrated conductive switch of claim 1, wherein the integrated conductive switch mechanically directs the RF signals from the FEM to the test equipment in response to a physical connection of a test cable.

3. The integrated conductive switch of claim 1, wherein the integrated conductive switch is a single assembly surface-mountable on a printed circuit board (PCB).

4. The integrated conductive switch of claim 1, wherein the integrated conductive switch is a single assembly merged into the FEM.

5. The integrated conductive switch of claim 1, wherein the integrated conductive switch is a single assembly merged into the antenna panel.

6. The integrated conductive switch of claim 1, wherein the unified structural framework comprises a shared housing configured to encapsulate the N conductive switch elements.

7. The integrated conductive switch of claim 6, wherein adjacent conductive switch elements within the shared housing are separated by a fixed spacing.

8. The integrated conductive switch of claim 1, further comprising a unified power distribution network integrated within the unified structural framework.

9. The integrated conductive switch of claim 1, wherein the unified structural framework comprises a single PCB mounting surface having a unified solder land pattern.

10. The integrated conductive switch of claim 9, wherein the unified solder land pattern comprises a plurality of contact pads distributed along a preset trace on the single PCB mounting surface.

11. The integrated conductive switch of claim 1, wherein N equals 4 and the N conductive switch elements are arranged in a 4×1 configuration.

12. The integrated conductive switch of claim 1, wherein the integrated conductive switch is configured to operate within a frequency range 3 (FR3) frequency range of 7-15 gigahertz.

13. The integrated conductive switch of claim 1, wherein the integrated conductive switch comprises a multi-line interboard connector configured to transmit both digital control signals and RF signals between a first circuit board and a second circuit board.

14. A method, comprising:
providing an integrated conductive switch comprising:
a unified structural framework; and
N conductive switch elements integrated within the unified structural framework, wherein N is an integer greater than 2;
in response to the integrated conductive switch operating in a signal path mode, routing, through the N conductive switch elements, radio frequency (RF) signals between a front-end module (FEM) and an antenna panel; and
in response to the integrated conductive switch operating in a testing mode, routing, through the N conductive switch elements, the RF signals between the FEM and a test equipment.

15. The method of claim 14, wherein routing the RF signals between the FEM and the test equipment comprises:
mechanically directing, by the integrated conductive switch, the RF signals from the FEM to the test equipment in response to a physical connection of a test cable.

16. The method of claim 14, wherein the integrated conductive switch is one of a single assembly surface-mountable on a printed circuit board (PCB), a single assembly merged into the FEM, or a single assembly merged into the antenna panel.

17. The method of claim 14, wherein the unified structural framework comprises a shared housing configured to encapsulate the N conductive switch elements.

18. The method of claim 17, wherein adjacent conductive switch elements within the shared housing are separated by a fixed spacing.

19. The method of claim 18, further comprising: integrating a unified power distribution network within the unified structural framework.

20. The method of claim 14, further comprising:
transmitting, through a multi-line interboard connector comprised in the integrated conductive switch, both digital control signals and RF signals between a first circuit board and a second circuit board.
